(19) United States
(12) Patent Application Publication
(10) Pub. No.: US 2012/0313820 A1
(43) Pub. Date: Dec. 13, 2012

(54) SYSTEM TECHNIQUE FOR CONICAL GEO-LOCATION OF RADIO FREQUENCY SOURCES

(75) Inventor: Anthony Keith Tyree, Tucson, AZ (US)

(73) Assignee: Raytheon Company, Waltham, MA (US)

(21) Appl. No.: 13/154,556

(22) Filed: Jun. 7, 2011

(51) Int. Cl. G01S 5/02

(52) U.S. Cl. 342/450

(57) ABSTRACT

A system comprises a single linear antenna array, an RF receiver and a processor. The processor includes an RF extraction module configured to extract information from the RF signal and a target location module. The target location module is configured to calculate a first target likelihood distribution for possible locations of the target object using information extracted from an RF signal received using a first antenna array orientation, calculate a second target likelihood distribution for possible locations of the target object using information extracted from an RF signal received using a second antenna array orientation, and identify a most probable location of the target object based on a combination of the first and second target likelihood distributions.

### BACKGROUND

Airborne surveillance and targeting systems can locate targets that broadcast radio frequency (RF) signals. These systems or platforms use expensive planar RF interferometer arrays. To locate a target using antenna information alone, a two axis linear antenna array is used. However, a two axis antenna implementation increases the cost of the platform, and the problem of arrangement of the two arrays can lead to increased size of the platform.

To reduce cost and size of the targeting platform, a single axis antenna array implementation is often used. However, single axis antenna array platforms are susceptible to a source of error that is sometimes called the Coning Effect. The Coning Effect results from the physics of a single axis antenna array. Using only phase and frequency measurements from a single axis array can only resolve the signal incidence angle to the surface of a cone whose axis is the axis of the antenna array. This coning can limit the geo-location accuracy of RF systems and constrains the operational utility of a targeting platform for situation awareness and targeting handover.

To overcome the Coning Effect, some single axis systems incorporate additional information obtained separately from the airborne ship to remove the coning error. This approach complicates the target sighting process. Some single axis systems require that the airborne ship reduce its altitude to mitigate the Coning Effect. To allow for low altitude flight on fast-moving platforms, a terrain following radar is typically deployed and the detection range of the system is reduced. Thus, the operational visibility of the targeting platform is limited.

### OVERVIEW

This document relates generally to geo-location systems and methods for automatically locating a target object, and in particular, to locating the target object using a single antenna array without additional outside information. A method example includes receiving a radio frequency (RF) signal from a target object using a single linear antenna array, calculating a first target likelihood distribution for possible locations of the target object using information extracted from the received RF signal, changing an orientation of the single linear antenna array, calculating a second target likelihood distribution for possible locations of the target object using information extracted from an RF signal received after the change in orientation, and identifying a most probable location of the target object based on a combination of the first and second target likelihood distributions. Relative motion of the observing platform between target measurements will affect the accuracy of the target location estimate. Thus, continuing to make target measurements and accumulating the combined target likelihood distributions will in general improve the target location estimate.

A system example includes a single linear antenna array, an RF receiver and a processor. The processor includes an RF extraction module configured to extract information from the RF signal and a target location module. The target location module is configured to calculate a first target likelihood distribution for possible locations of the target object using information extracted from an RF signal received using a first antenna array orientation, calculate a second target likelihood distribution for possible locations of the target object using information extracted from an RF signal received using a second antenna array orientation, and identify a most probable location of the target object based on a combination of the first and second target likelihood distributions.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an RF interferometer cone.

FIG. 2 is a flow diagram of a method of geo-location of an RF source.

FIG. 3 shows an example of a target distribution useful for geo-location.

FIG. 4 shows an example of a target distribution obtained from simulation.

FIG. 5 shows another example of a simulated target distribution.

FIG. 6 shows an example of combining target distributions.

FIG. 7 is a block diagram of portions of an example of a system for geo-location of an RF source.

FIG. 8 shows an example of a coarse grid used in geo-location.

FIG. 9 shows an example of a finer grid used in geo-location.

### DETAILED DESCRIPTION

This document discusses systems and methods for geo-location of RF sources while overcoming Coning Effect without resorting to using a multi-array antenna, or limiting operational visibility. A conical geo-location system architecture is described that uses the Coning Effect to its advantage to improve geo-location accuracy. The system architecture can perform precise geo-location using a single axis antenna array and with limited or no translational motion of the surveillance and targeting platform. The system accomplishes this by implementing processing-efficient search algorithm that postulates the target to exist on the ground, or at a known altitude above the ground, and searches a defined surface grid for the point that minimizes an error function that corresponds to the target location.

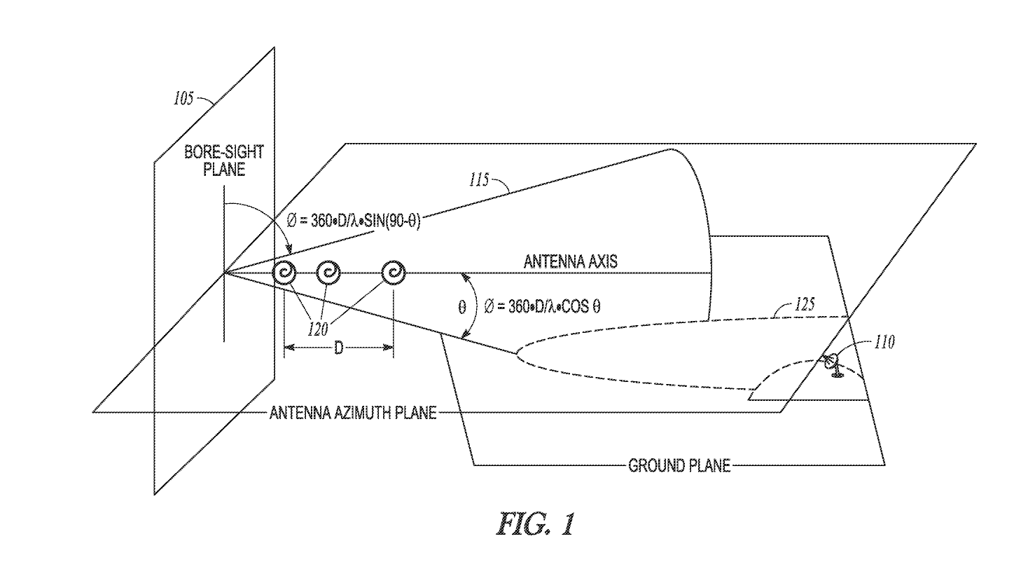

FIG. 1 illustrates an RF interferometer cone 115 for an RF signal incident on an airborne single array antenna 120. Linear antenna array 120 receives an RF signal transmit by a target 110. The incident angle of the incoming RF signal creates phase differences between elements of the single linear antenna array 120. If the target 110 is on the bore-sight of the plane 105 of the antenna array, the far field RF signal from the target strikes the antenna elements with no phase difference among the antenna elements. If the RF signal is received off bore-sight, there is a difference in phase (e.g., a phase shift) between any two of the antenna elements (base-lines).

The phase shift is equal to

Φ=360*D/λ*sin(90−θ), (1)

or, Φ=360*D/λ*cos(θ), (2)

where D is the spacing between elements of the antenna, λ is the wavelength of the RF signal (which can be determined from the RF signal frequency f), and θ is the angle of the target off bore-sight from the antenna. An RF signal received from a target anywhere on the interferometer cone 115 causes a different phase shift between antenna base-lines, depending on the inter-element spacing (D). If a base-line space is greater than a half wave-length of the incoming target RF signal, then there is an ambiguity created on the individual phase measurement. The phase measurement has a missing unknown term (N*360), referred to as an ambiguity. This ambiguity is needed to calculate the total unambiguous phase shift (Φ), where

Φ=360*N+Φ_{MEASURE}. (3)

A method of resolving this ambiguity (N*360) is to design the antenna array such that the base-line spaces are pseudo-prime multiples of the half wave-length of the highest frequency of operation. The pseudo-prime condition is met when any linear combination of the base-line spaces produces a numeric value of a half-wavelength or less. For instance, if one base-line spacing is 3*λ/2 and a second base-line is 2*λ/2 then the difference is λ/2 and the antenna array is unambiguous. With this condition met it can be shown that only one unique set of antenna phase shifts can result for a given antenna cone angle. Thus, a unique inverse relationship exists to compute the single antenna cone angle 115 from a set of phase measurements and the antenna array is said to be unambiguous.

However, even if the cone angle is computed, ambiguity still exists in the determined final position of the target, which can be anywhere on the cone. If the array is not designed with sufficient elements to produce a resolved unambiguous phase measurement, then the target could lie on the surface of multiple cones, one cone for each possible N in equation 3. This condition exists in single long base-line antenna arrays (only two elements).

Given that the antenna array is designed to be unambiguous, if a second unambiguous linear antenna array is placed orthogonal to the first linear antenna array, a second interferometer array cone can be calculated using phase shift and frequency. An intersection of the two cones can yield a true line of sight for the target. But as explained previously, a second antenna array negatively impacts the cost and size of a targeting platform.

A solution to locating the target is to find the best intersection of multiple cones determined with a single linear array antenna. To find the multiple cones, the airborne platform changes the orientation of the one linear array antenna and calculates a different interferometer cone for the different orientations. In this way, advantage is taken of the Coning Effect to find the true or actual target location.

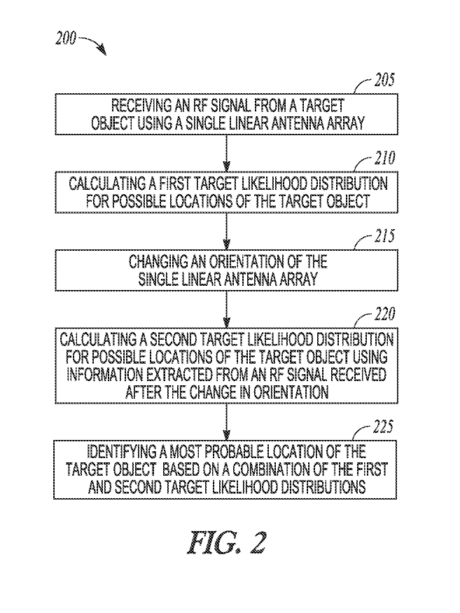

FIG. 2 is a flow diagram of a method 200 of geo-location of an RF source. The method provides the geo-location using a single linear antenna array. At block 205, an RF signal is received from a target object or RF source using the single linear antenna array.

At block 210, a first target likelihood distribution is calculated for possible locations of the target object. The first target likelihood distribution is calculated using information extracted from the received RF signal. Returning to FIG. 1, it can be seen that the intersection of the interferometer cone 115 and a planar surface, or near planar surface such as ground surface, is a parabola 125. Because it is assumed that the target 110 is on the ground or at a known altitude, the possible positions of the RF source are reduced to a parabola. In some examples, the first target likelihood distribution is calculated for a section of the ground terrain and the shape of the distribution is parabolic.

According to some examples, the information extracted from the RF signal includes frequency and phase shift information. Phase shift can be the phase difference calculated between any two antenna elements in the single linear antenna array; however the phase shift from the longest base-line antenna pair or a linear combination of all phase shifts is normally used for higher accuracy. A measurement of conical angle of incidence of the RF signal can be calculated using the frequency and phase shift information. In FIG. 1, the conical angle of incidence of an RF signal is shown as θ, and the angle of incidence can be calculated using equation (1) or equation (2) above.

A target likelihood distribution for possible locations of the target can include an error function determined over an identified grid of ground surface or near ground surface locations. The values of the error function can be based on the difference between a calculation of an expected conical angle of incidence for each point or location on the identified grid and the measured conical angle of incidence.

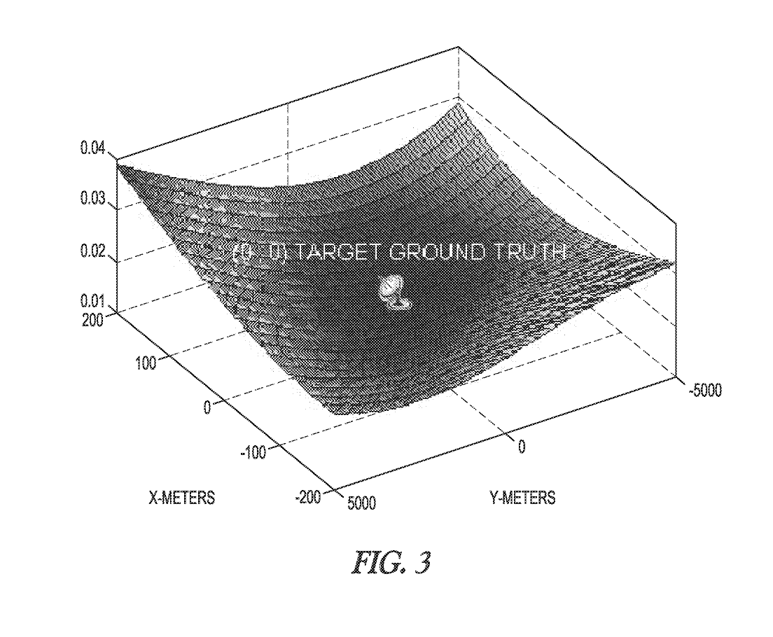

FIG. 3 shows an example of a target distribution. A grid of locations for the target is identified. In some examples, the grid is identified from a line of sight from the single array antenna. For each location on the grid, the expected conical angle of incidence is calculated. The surface of the target distribution can be the values of an error function calculated for the expected values and the measured values of the conical angle of incidence. It can be seen that the values of the error function are lower near the actual position of the target. However, as described previously, the location of the target is complicated by the Coning Effect.

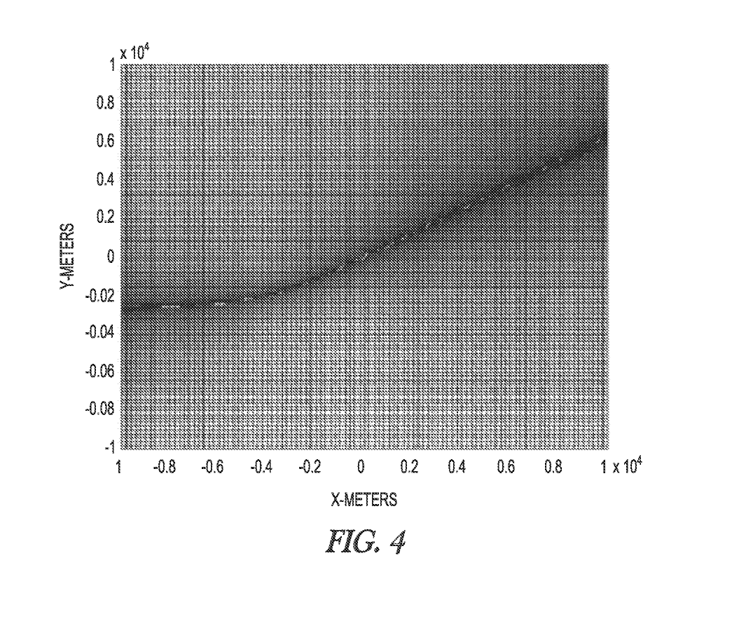

FIG. 4 is an example of a target distribution obtained from simulation and shows the influence of the Coning Effect. The values of the determined error function are lowest along a parabolic region having a wide parabolic curve. Any of the locations having the lowest error function value are possible locations of the target.

Returning to FIG. 2, at block 215, the orientation of the single linear antenna array is changed. In some examples, the orientation of the antenna is changed by changing the orientation of the own ship, such as by rotational or translational motion of the own-ship. In some examples, the single linear array antenna is rotatably mounted at the own ship, such as by mounting the antenna on a gimbal. The orientation of the antenna is changed by rotating the rotating the single linear antenna array about an antenna axis.

At block 220, a second target likelihood distribution for possible locations of the target object is calculated using information extracted from an RF signal received after the change in orientation.

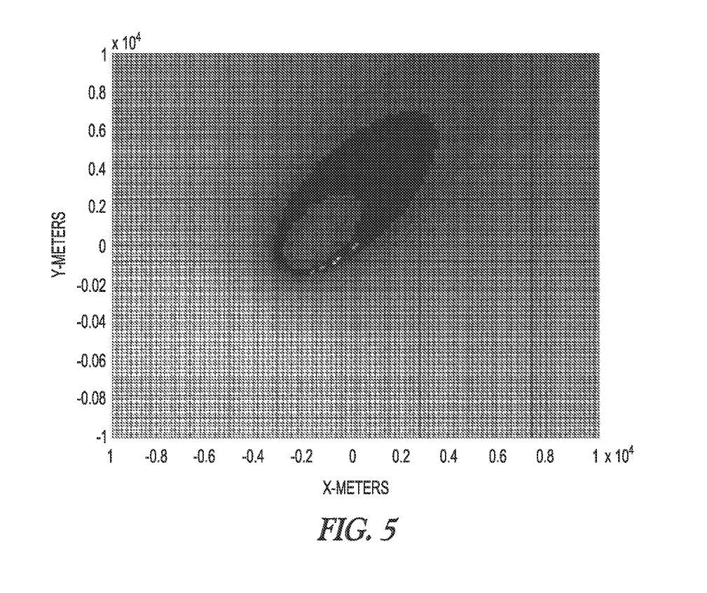

FIG. 5 shows another example of a simulated target distribution after the orientation of the antenna is changed. The values of the determined error function are lowest along an ellipse having a narrower conic curve than the example of FIG. 4. Again, any of the locations along the curve are possible locations of the target.

At block 225, the most probable location of the target object is identified based on a combination of the first and second target likelihood distributions. Typically, the combination of the first and second target distributions includes the intersection of the distributions.

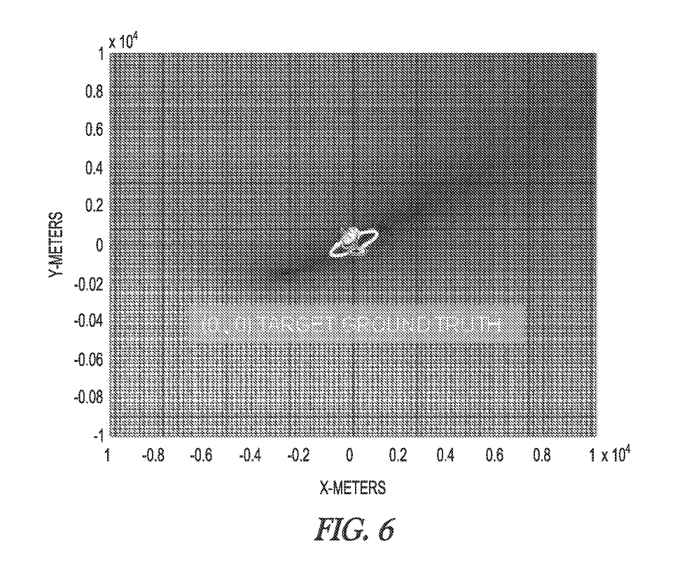

FIG. 6 shows an example of combining target distributions. A first region of lowest error function value is determined for the first likelihood target distribution, and a second region of lowest error function value for the second likelihood target distribution. FIG. 6 shows the intersection of the regions of lowest error function value. In certain examples, the region of lowest error function value is the region of grid locations having an error function value less than a specified threshold error function value. The location or locations where the error function has the lowest error function value is the most probable location of the target.

The actual conic sections of an interferometer cone and ground surface, such as the conic section 125 shown in FIG. 1, do not need to be calculated. The conic sections can be seen in the error function values of the FIGS. 4-6. To find the conic sections would mean to look for many grid locations with error function values of zero or near zero. The Figures show that the actual conic sections do not have to be found, but the sections are embedded in the error function data and the data can be searched for the smallest error function value that is small enough to be near the target location. There is a time constraint in calculating the error functions using a geo-location system that is part an airborne platform, and not having to find the conic sections simplifies the geo-location method 200.

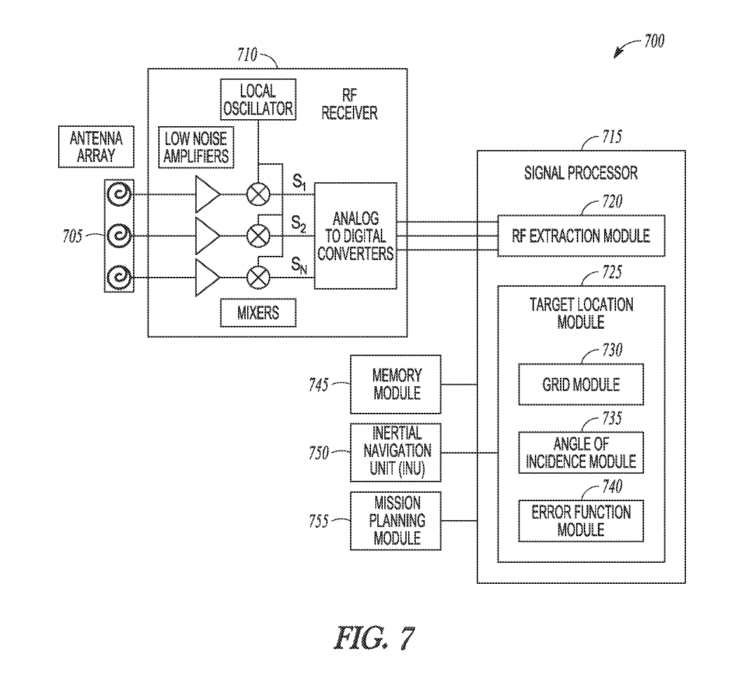

FIG. 7 is a block diagram of portions of an example of a system 700 for geo-location of an RF source. The geo-location system can be included on a targeting or navigation platform. The platform can be included in, among other things, an unmanned aerial vehicle (UAV), a piloted aircraft, a satellite, or a missile. The system 700 includes a single linear antenna array 705, an RF receiver 710 communicatively coupled to the single linear antenna array, and a processor such as a signal processor 715 communicatively coupled to the RF receiver 710. The communicative coupling allows signals to be communicated between the single linear antenna array 705, RF receiver 710, and signal processor 715 even though there may be intervening circuitry between them.

The single linear antenna array 705 includes multiple (e.g., three) antenna elements. The spacing of the antenna elements can be chosen to be a prime integer multiple of expected wavelengths of the RF signal. The signal processor 715 can be a digital signal processor, application specific integrated circuit (ASIC), field programmable gate array (FPGA), microprocessor, or other type of processor, interpreting or executing instructions in software modules or firmware modules. The signal processor 715 can include other modules or sub-modules configured to perform the functions described. These modules may be configured by software, hardware, firmware or any combination thereof. Multiple functions can be performed by one or more of the modules as desired.

The signal processor 715 includes an RF extraction module 720 configured to extract information from the RF signal, such as frequency and phase shift information. The signal processor 715 further includes a target location module 725 configured to calculate a first target likelihood distribution for possible locations of the target object. The first target likelihood distribution is calculated using information extracted from an RF signal received using a first antenna array orientation. The target location module 725 is further configured to calculate a second target likelihood distribution for possible locations of the target object. The second target likelihood distribution is calculated using information extracted from an RF signal received using a second orientation.

In certain examples, the signal processor 715 initiates a change in orientation of the antenna between determining the first and second target likelihood distributions, such as by initiating own-ship translational motion to change orientation of the single linear antenna array. In certain examples, the single linear antenna array is mounted to a gimbal configured to change orientation of the single linear antenna array, and the processor initiates the change in orientation of the antenna by initiating movement of the gimbal, such as through a servo motor for example. The target location module 725 identifies the most probable location of the target object based on a combination of the first and second target likelihood distributions, such as by the method 200 described previously.

In some examples, the target location module 725 accepts input from an Inertial Navigation Unit (INU) 750 to reference the error function grid to an earth fixed inertial reference frame. The INU can provide estimates of the system 700 location and inertial orientation. In this case the resulting final target location can be referenced to the earth fixed inertial reference frame as is any terrain map and or terrain features used to construct the grid locations and error function.

In some examples, the target location module 725 accepts inputs from a Mission Planning Module 755 to reference the error function grid to an earth fixed inertial reference frame. The mission plan provides estimates of the system 700 locations and inertial orientation versus time. In this case a reference clock can be used to estimate the system 700 location and inertial orientation, and thereby establish an earth fixed inertial reference.

According to some examples, the target location module 725 includes a grid module 730 to identify a grid of ground surface or near ground surface locations that are possible target locations. The single linear antenna array 705 can have a directional gain pattern. The grid module 730 may identify a grid of ground surface locations or near ground surface locations from a bore-sight direction of the single linear antenna array in the direction of the gain pattern. In some examples, the system 700 may include a memory circuit 745 integral to, or communicatively coupled to, the signal processor 715. The memory may store a terrain map that can be used to set up the grid.

In some examples, the target location module 725 includes an angle of incidence module 735 configured to calculate a measurement of conical angle of incidence of the RF signal using extracted frequency and phase shift information, and an error function module 740 configured to determine an error function over the identified grid. The error function can be determined using the measurement of the conical angle of incidence calculated from the received RF signal and using measurements of conical angle of incidence calculated for locations on the identified grid. The possible locations of the target are represented by grid locations having a lowest value of the error function. In some examples, the first and second target distributions are regions of lowest error function value, and the intersection of the regions of lowest error function value is identified as the most probable location of the target object.

The error function can be calculated in multiple ways. For instance, an array axis direction cosine (DC_{Y}) can be calculated from the frequency and phase shift information, such as by isolating cos θ in equation (2) and solving for cos θ using the extracted phase shift and frequency information. Expected values of direction cosine can be calculated for the locations on the identified grid. The error function can be based on the difference between the calculated values of direction cosine and the expected values of direction cosine calculated for the grid.

In some examples, the angle of incidence module 735 is configured to calculate an array axis direction cosine using the frequency and phase shift information (DC_{Y,MEASURED}), and to calculate an array axis direction cosine for locations on the identified grid (DC_{Y,GRID}). The error function module 740 can calculate the error function using the squared difference between the array axis direction cosine calculated using the frequency and phase shift information (DC_{Y,MEASURED}) and the calculated grid location array axis direction cosine (DC_{Y,GRID}) for locations on the identified grid (e.g., Σ(ΔDC_{Y})²).

The grid module 730 can be configured to establish an own-ship orthogonal reference frame. The reference frame includes an x-axis, y-axis, and z-axis, and the axis of the single linear antenna array can be coincident with the y-axis of the orthogonal reference frame. The angle of incidence module 735 can be configured to calculate the grid location direction cosine (DC_{Y,GRID}) for the y-axis of the reference frame.

In some examples, the error function can be based on the angle of incidence θ, which can also be referred to as the array cone angle (Cone). The cone angle can be calculated by such as by isolating cos θ in equation (2), solving for cos θ using the measured phase shift and frequency information, and using inverse cosine to find the cone angle. The error function can be based on the difference between the values of cone angle determined from the measurements and the expected values of cone angle determined for the grid locations. The angle of incidence module 735 can be configured to calculate an array cone angle using the frequency and phase shift information (Cone_{,MEASURED}) and calculate a grid array cone angle (Cone_{,GRID}) for the locations on the identified grid. The error function module 740 can be configured to calculate, for locations on the grid, the error function using the squared difference between the grid cone angle and the cone angle calculated using the frequency and phase shift information (e.g., Σ(ΔCone)²).

In some examples, the error function can be based on the extracted phase shift Φ. The error function can be based on the difference between the values of phase shift extracted by the RF extraction module 720 and expected values of interferometer phase shift calculated for the grid.

The angle of incidence module 735 can be configured to calculate the expected antenna phase shift for locations on the identified grid. In some examples, the grid module 730 is configured to establish an own-ship orthogonal reference frame. The reference frame includes an x-axis, y-axis, and z-axis, and the axis of the single linear antenna array can be coincident with the y-axis. The angle of incidence module 735 can be configured to calculate a grid location direction cosine for the y-axis, and calculate the expected interferometer phase shift between elements of the single linear antenna array using the frequency information and the y-axis grid location direction cosine. The error function module 740 can be configured to calculate, for locations on the grid, the error function using the squared difference between the measured phase shift information and the expected antenna phase shift for the grid locations (Σ(Φ)²).

As described previously in regard to FIG. 1, the single linear antenna array includes multiple antenna elements 120 and phase shift can be the phase difference calculated between any two antenna elements in the single linear antenna array. In some examples, the single linear antenna array 705 includes only two antenna elements.

Typically, more than two elements are used to remove ambiguity in the determined phase shift. However, calculating multiple error functions and finding the intersections of the error functions will resolve the phase ambiguity.

Accumulation of multiple error functions over time (from multiple signal measurements) as the antenna array is moved relative to the target will result in better accuracy of the estimated target position. This is because the combined error function from the multiple measurements will have a steeper gradient and the variation of the combined error function is also reduced from the multiple measurements. In some examples, one cumulative error function is calculated from the individual error functions. As the cumulative error function is calculated, a major low point corresponding to the position of the target begins to develop. The ambiguity in the measurements is eventually resolved with selection of the final target position.

Other search strategies can be used to identify a grid for calculating target distributions. For instance, a coarse grid having one accuracy can be used to find a rough or approximate location of the target, and the coarse grid can be used to define a fine grid having a greater accuracy that is used to determine the final target position.

According to some examples, the grid module 730 can identify a coarse grid of ground surface locations, or near ground surface locations, and the error function module 740 can calculate the error function for locations on the coarse grid using the extracted frequency and phase shift information. The target location module 725 may identify a coarse grid target position using the coarse grid error function.

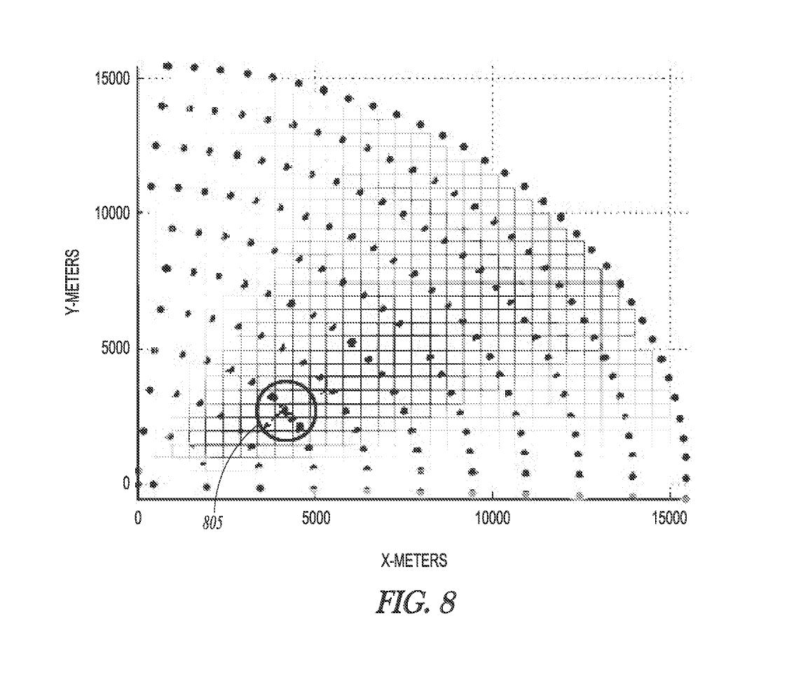

FIG. 8 shows an example of a coarse grid. The coarse grid can be a ninety degree sweep from the bore-sight from the antenna. The target will typically be close to the line of sight from the antenna, given that the antenna array has an amplitude gain pattern that limits its signal reception off bore-sight. The coarse grid has a first grid size (e.g., a 1000 meter step size). Using the error function calculated for the coarse grid, the target location module 725 determines a target position 805 that is used as a coarse position seed for the finer resolution determination. The darker shading indicates regions of lower error function values.

Using the identified coarse grid target position, the grid module 730 then identifies a fine grid of ground surface locations or near ground surface locations.

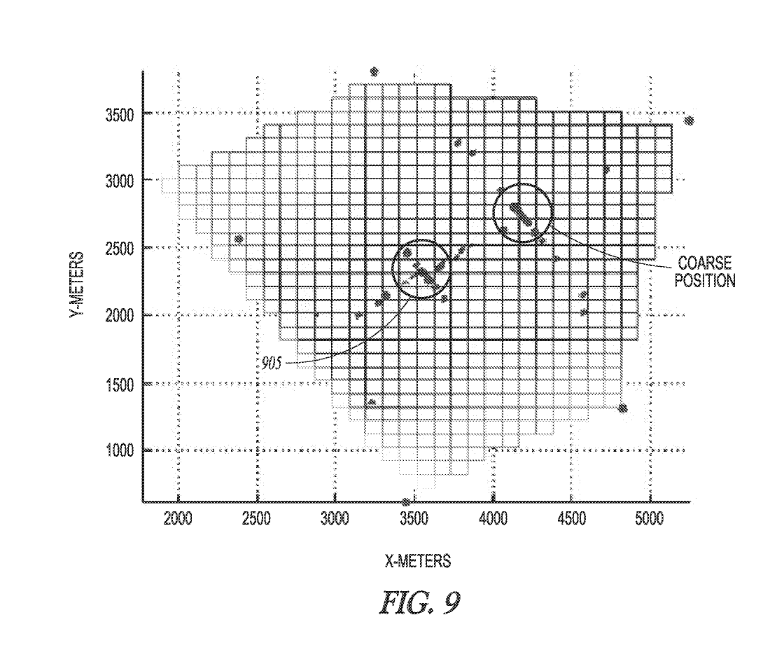

FIG. 9 shows a fine grid with smaller step size (e.g., 100 meters) than the coarse grid. The error function module 740 calculates the error function for locations on the fine grid using the frequency and phase shift information. The target location module 725 identifies the final target location 905 using the fine grid error function. In certain examples, the fine search is orthogonal to the coarse search. In certain examples, the fine search is aligned to be orthogonal with the gradient of the error function or parallel to the gradient of the error function.

In some examples, the grid can be refined multiple times with the step size getting smaller and smaller (e.g., until the step size is one meter). In some examples, the grid module 730 is configured to identify a coarse grid of ground surface locations or near ground surface locations for multiple targets and identify multiple fine grids using coarse target positions identified by the target location module.

In some examples, the signal processor 715 includes a memory circuit 745 integral to or communicatively coupled to the signal processor 715. The grid module 730 and the target location module 725 identify the coarse grid and identify the coarse target position, respectively, in real time. The grid module 730 and the target location module 725 may identify the fine grid and final target locations, respectively, using stored measurements, such as stored grid locations and stored phase shift and frequency information for example.

In some examples, the error function module 740 calculates a gradient of the coarse grid error function. The gradient of the error function provides a direction for the next search, such as in the direction of decreasing error values. The grid module 730 can use the gradient of the coarse grid error function to identify a new coarse grid search or use the gradient of the coarse grid error function to identify the fine grid. This may allow the target location module 725 to spiral in on the final target position.

These search strategies can be expanded beyond a ground surface grid. In some examples, the grid module 730 identifies a three-dimensional (3D) grid of possible target locations. In certain examples, the 3D grid is determined using a 3D ninety degree sweep from the bore-sight from the antenna. The angle of incidence module 735 is configured to calculate a measurement of conical angle of incidence of the RF signal using extracted frequency and phase shift information. The error function module 730 configured to determine an error function using the measurement of the conical angle of incidence calculated from the received RF signal and a measurement of conical angle of incidence calculated for the locations on the identified 3D grid. The possible locations of the target are represented by grid locations having a lowest value of the error function. Multiple 3D regions are determined by changing the orientation of the antenna. The resulting regions of lowest error functions may have a conical shape rather than a parabolic shape. The final target location is determined from the intersection of the regions of lowest error.

The conical geo-location architecture described uses an efficient search approach coupled with a unique error function that improves the accuracy of the calculated target position. Unlike conventional geo-location approaches, own-ship motion and antenna rotational motion, that would normally accentuate error the Coning Effect on antenna phase and line of sight measurements, improve the resulting geo-location target position accuracy. This conical approach to geo-location provides the added feature of target position convergence with little to no translational motion that allows the architecture to be used on low velocity platforms. This approach is also extendable to multi-ship single axis antenna geo-location missions with no Coning Effect or Coning Error induced by different own-ship altitudes. The conical approach to geo-location can be used for navigation as well as surveillance or targeting of the RF source.

The conical approach to geo-location is also amenable to other targeting platforms, sensor suites, signal types and signal medium. For example, it can be used in conjunction with acoustic sensor arrays on one or more submarines to locate ocean surface objects. In this specific example the sensors' inter-element phase shift is typically specified as the time shift of the correlated sound spectrum between acoustic sensor pairs.

### Additional Notes

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, the code can be tangibly stored on one or more volatile or non-volatile computer-readable media during execution or at other times. These computer-readable media can include, but are not limited to, hard disks, removable magnetic disks, removable optical disks (e.g., compact disks and digital video disks), magnetic cassettes, memory cards or sticks, random access memories (RAM's), read only memories (ROM's), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
a single linear antenna array;
an RF receiver communicatively coupled to the single linear antenna array; and
a processor communicatively coupled to the RF receiver, wherein the processor includes:
an RF extraction module configured to extract information from the RF signal; and
a target location module configured to:
calculate a first target likelihood distribution for possible locations of the target object, wherein the first target likelihood distribution is calculated using information extracted from an RF signal received using a first antenna array orientation;
calculate a second target likelihood distribution for possible locations of the target object, wherein the second target likelihood distribution is calculated using information extracted from an RF signal received using a second orientation; and
identify a most probable location of the target object based on a combination of the first and second target likelihood distributions.

2. The system of claim 1,
wherein the RF extraction module is configured to extract frequency and phase shift information from the RF signal, wherein phase shift is the phase difference calculated between any two antenna elements in the single linear antenna array, and
wherein the target location module includes:
a grid module configured to identify a grid of ground surface or near ground surface locations that are possible target locations;
an angle of incidence module configured to calculate a measurement of conical angle of incidence of the RF signal using extracted frequency and phase shift information; and
an error function module configured to determine an error function over the identified grid, wherein the error function is determined using the measurement of the conical angle of incidence calculated from the received RF signal and a measurement of conical angle of incidence calculated for locations on the identified grid, and wherein possible locations of the target are represented by grid locations having a lowest value of the error function.

3. The system of claim 2, wherein the target location module is configured to:
determine a region of lowest error function value for the first likelihood target distribution;
determine a region of lowest error function value for the second likelihood target distribution; and
identify an intersection of the regions of lowest error function value as the most probable location of the target object.

4. The system of claim 3, wherein the target location module is configured to identify a region of lowest error function value as a region of grid locations having an error function value less than a specified threshold error function value.

5. The system of claim 2,
wherein the angle of incidence module is configured to:
calculate an array axis direction cosine using the frequency and phase shift information (DC_{Y,MEASURED}); and
calculate an array axis direction cosine for locations on the identified grid (DC_{Y,GRID}), and
wherein the error function module is configured to calculate the error function using the squared difference between the array axis direction cosine calculated using the frequency and phase shift information (DC_{Y,MEASURED}) and the calculated grid location array axis direction cosine (DC_{Y,GRID}) for locations on the identified grid.

6. The system of claim 5,
wherein the grid module is configured to establish an own-ship orthogonal reference frame, wherein the reference frame includes an x-axis, y-axis, and z-axis, and an axis of the single linear antenna array is coincident with the y-axis, and
wherein the angle of incidence module is configured to calculate the grid location direction cosine for the y-axis.

7. The system of claim 2,
wherein the angle of incidence module is configured to:
calculate an array cone angle using the frequency and phase shift information; and
calculate a grid array cone angle for the locations on the identified grid, and
wherein the error function module is configured to calculate, for locations on the grid, the error function using the squared difference between the grid cone angle and the cone angle calculated using the frequency and phase shift information.

8. The system of claim 2,
wherein the angle of incidence module is configured to calculate an expected antenna phase shift for locations on the grid, and
wherein the error function module is configured to calculate, for locations on the grid, the error function using the squared difference between the measured phase shift information and the expected antenna phase shift for the grid locations.

9. The system of claim 8,
wherein the grid module is configured to establish an own-ship orthogonal reference frame, wherein the reference frame includes an x-axis, y-axis, and z-axis, and an axis of the single linear antenna array is coincident with the y-axis, and
wherein the angle of incidence module is configured to:
calculate a grid location direction cosine for the y-axis; and
calculate the expected interferometer phase shift between elements of the single linear antenna array using the frequency information and the y-axis grid location direction cosine.

10. The system of claim 8, wherein the single linear antenna array includes only two antenna elements.

11. The system of claim 2,
wherein the single linear antenna array has a directional gain pattern, and
wherein the grid module is configured to identify a grid of ground surface locations or near ground surface locations from a bore-sight direction of the single linear antenna array in the direction of the gain pattern.

12. The system of claim 2,
wherein the grid module is configured to identify a coarse grid of ground surface locations or near ground surface locations,
wherein the error function module is configured to calculate the error function for locations on the coarse grid using the frequency and phase shift information,
wherein the target location module is configured to identify a coarse grid target position using the coarse grid error function,
wherein the grid module is configured to identify a fine grid of ground surface locations or near ground surface locations using the identified coarse grid target position,
wherein the error function module is configured to calculate the error function for locations on the fine grid using the frequency and phase shift information, and
wherein the target location module is configured to identify the final target location using the fine grid error function.

13. The system of claim 12,
wherein the error function module is configured to calculate a gradient of the coarse grid error function, and
wherein the grid module is configured to identify the fine grid using the gradient of the coarse grid error function.

14. The system of claim 12, including:
a memory circuit integral to or communicatively coupled to the processor,
wherein the grid module and the target location module are configured to identify the coarse grid and identify the coarse target position, respectively, in real time, and
wherein the grid module and the target location module are configured to identify the fine grid and final target locations, respectively, using stored measurements.

15. The system of claim 12, wherein the grid module is configured to:
identify a coarse grid of ground surface locations or near ground surface locations for multiple targets; and
identify multiple fine grids using coarse target positions identified by the target location module.

16. The system of claim 1, wherein the target location module includes:
a grid module configured to identify a three-dimensional (3D) grid of possible target locations;
an angle of incidence module configured to calculate a measurement of conical angle of incidence of the RF signal using extracted frequency and phase shift information; and
an error function module configured to determine an error function using the measurement of the conical angle of incidence calculated from the received RF signal and a measurement of conical angle of incidence calculated for locations on the identified 3D grid, and wherein possible locations of the target are represented by grid locations having a lowest value of the error function.

17. The system of claim 1, wherein the single linear antenna array is mounted to a gimbal configured to change orientation of the single linear antenna array.

18. The system of claim 1, wherein the processor is configured to initiate own-ship translational motion to change orientation of the single linear antenna array.

19. A method comprising:
receiving a radio frequency (RF) signal from a target object using a single linear antenna array;
calculating a first target likelihood distribution for possible locations of the target object, wherein the first target likelihood distribution is calculated using information extracted from the received RF signal;
changing an orientation of the single linear antenna array;
calculating a second target likelihood distribution for possible locations of the target object using information extracted from an RF signal received after the change in orientation; and
identifying a most probable location of the target object based on a combination of the first and second target likelihood distributions.

20. The method of claim 19,
wherein the information extracted from the RF signal includes frequency and phase shift information, wherein phase shift is the phase difference calculated between any two antenna elements in the single linear antenna array, and
wherein calculating a likelihood target distribution includes:
calculating a measurement of conical angle of incidence of the RF signal using the frequency and phase shift information; and
determining an error function over an identified grid of ground surface or near ground surface locations, wherein the error function is determined using the measurement of the conical angle of incidence calculated from the received RF signal and a measurement of conical angle of incidence calculated for locations on the identified grid, and
wherein possible locations of the target are represented by grid locations having a lowest value of the error function.

21. The method of claim 20, including:
determining a region of lowest error function value for the first likelihood target distribution; and
determining a region of lowest error function value for the second likelihood target distribution, and
wherein identifying a most probable location of the target object includes identifying an intersection of regions of lowest error function value as the most probable location of the target object.

22. The method of claim 20, wherein determining an error function includes:
calculating an array axis direction cosine using the frequency and phase shift information (DC_{Y,MEASURED});
calculating an array axis direction cosine for locations on the identified grid (DC_{Y,GRID}), and
calculating the error function using the squared difference between the array axis direction cosine calculated using the frequency and phase shift information (DC_{Y,MEASURED}) and the calculated grid location array axis direction cosine (DC_{Y,GRID}) for locations on the identified grid.

23. The method of claim 20, wherein determining an error function includes:
calculating an array cone angle using the frequency and phase shift information;
calculating a grid array cone angle for the locations on the identified grid; and
calculating, for locations on the grid, the error function using the squared difference between the grid cone angle and the cone angle calculated using the frequency and phase shift information.

24. The method of claim 20, wherein determining an error function includes:
calculating an expected antenna phase shift for locations on the grid; and
calculating the error function using the squared difference between the measured phase shift information and the expected antenna phase shift for the grid locations.

25. The method of claim 24, wherein calculating an expected phase shift for a location on the identified grid includes:
establishing an own-ship orthogonal reference frame, wherein the reference frame includes an x-axis, y-axis, and z-axis, wherein the single linear antenna array is coincident with the y-axis;
calculating the grid location direction cosine for the y-axis; and
calculating an expected interferometer phase shift between elements of the single linear antenna array using the frequency information and the y-axis grid location direction cosine.

26. The method of claim 24, wherein receiving an RF signal includes receiving the RF signal using a single linear antenna array having only two antenna elements.

27. The method of claim 20, wherein calculating an error function for locations of an identified grid includes:
identifying a coarse grid of ground surface locations or near ground surface locations;
calculating the error function for locations on the coarse grid using the frequency and phase shift information;
identifying a coarse grid target position using the coarse grid error function;
identifying a fine grid of ground surface locations or near ground surface locations using the coarse grid target position;
calculating the error function for locations on the fine grid using the frequency and phase shift information; and
identifying the final target location using the fine grid error function.

28. An unmanned aerial vehicle (UAV) having an electronic targeting system comprising:
a single linear antenna array;
an RF receiver communicatively coupled to the single linear antenna array; and
a processor communicatively coupled to the RF receiver, wherein the processor includes:
an RF extraction module configured to extract information from the RF signal; and
a target location module configured to:
calculate a first target likelihood distribution for possible locations of the target object, wherein the first target likelihood distribution is calculated using information extracted from an RF signal received using a first antenna array orientation;
calculate a second target likelihood distribution for possible locations of the target object, wherein the second target likelihood distribution is calculated using information extracted from an RF signal received using a second orientation; and
identify a most probable location of the target object based on a combination of the first and second target likelihood distributions.

29. The UAV of claim B1,
wherein the RF extraction module is configured to extract frequency and phase shift information from the RF signal, wherein phase shift is the phase difference calculated between any two antenna elements in the single linear antenna array,
wherein the target location module includes:
a grid module configured to identify a grid of ground surface or near ground surface locations that are possible target locations;
an angle of incidence module configured to calculate a measurement of conical angle of incidence of the RF signal using extracted frequency and phase shift information; and
an error function module configured to determine an error function over the identified grid, wherein the error function is determined using the measurement of the conical angle of incidence calculated from the received RF signal and a measurement of conical angle of incidence calculated for locations on the identified grid, and wherein possible locations of the target are represented by grid locations having a lowest value of the error function.

30. The UAV of claim 29, wherein the target location module is configured to:
determine a region of lowest error function value for the first likelihood target distribution;
determine a region of lowest error function value for the second likelihood target distribution; and
identify an intersection of the regions of lowest error function value as the most probable location of the target object.
